(19) United States
(12) Patent Application Publication
(10) Pub. No.: US 2014/0135076 A1
(43) Pub. Date: May 15, 2014

(54) MOBILE TERMINAL AND METHOD OF CONTROLLING THE SAME

(71) Applicant: Yeri LEE, Seoul (KR)

(72) Inventor: Yeri LEE, Seoul (KR)

(21) Appl. No.: 14/077,889

(22) Filed: Nov. 12, 2013

(30) Foreign Application Priority Data
Nov. 15, 2012 (KR) 10-2012-0129718

(51) Int. Cl. H04M 1/60; G10L 15/00

(52) U.S. Cl. CPC H04M 1/6041; G10L 15/00
USPC 455/569.1

(57) ABSTRACT

A mobile terminal may include an audio output module to output sound, a microphone to receive a user's voice input, a detecting device to detect a voice control command, and a controller to control the audio output module to adjust the volume of the sound output by the audio output module based on the voice control command.

### CROSS-REFERENCE TO RELATED APPLICATION(S)

This application claims priority under 35 U.S.C. §119 to Korean Application No. 10-2012-0129718 filed on Nov. 15, 2012, whose entire disclosure is hereby incorporated by reference.

### BACKGROUND

1. Field

This relates to a mobile terminal capable of controlling a terminal using voice.

2. Background

Mobile devices may support multiple functions such as voice and video calling, inputting and/or outputting information, storing data and the like.

Multifunctional terminals may capture still images or moving images, play music or video files, play games, receive broadcast signals and the like, so as to be implemented as an integrated multimedia player.

### BRIEF DESCRIPTION OF THE DRAWINGS

The embodiments will be described in detail with reference to the following drawings in which like reference numerals refer to like elements wherein:

FIG. 1 is a block diagram of a mobile terminal in accordance with one exemplary embodiment;

FIG. 2A is a front perspective view of a mobile terminal in accordance with one exemplary embodiment;

FIG. 2B is a rear perspective view of the mobile terminal shown in FIG. 2A;

FIG. 3 is a flowchart of a method of controlling a mobile terminal in accordance with an exemplary embodiment;

FIGS. 4A to 4C are conceptual views of the method shown in FIG. 3 according various exemplary embodiments;

FIG. 5 is a flowchart of a method of adjusting a volume level based on volume recorded in a memory of a mobile terminal, in accordance with an exemplary embodiment;

FIGS. 6A and 6B are conceptual views of the method shown in FIG. 5 according to various exemplary embodiments;

FIG. 7 is a flowchart of a method of adjusting a volume level using a sensor mounted in the mobile terminal, in accordance with an exemplary embodiment; and

FIGS. 8A and 8B are conceptual views of the method shown in FIG. 7 according to various exemplary embodiments.

### DETAILED DESCRIPTION

Description will now be given in detail of an antenna device and a mobile terminal having the same according to the exemplary embodiments, with reference to the accompanying drawings. For the sake of brief description with reference to the drawings, the same or equivalent components will be provided with the same reference numbers, and description thereof will not be repeated. A singular representation may include a plural representation as far as it represents a definitely different meaning from the context.

A mobile terminal disclosed herein may include a portable phone, a smart phone, a laptop computer, a digital broadcast terminal, a personal digital assistant (PDA), a portable multimedia player (PMP), a navigator, and the like. However, it may be easily understood by those skilled in the art that the configuration according to the exemplary embodiments of this specification can be applied to stationary terminals such as digital TV, desktop computers and the like excluding a case of being applicable only to the mobile terminals.

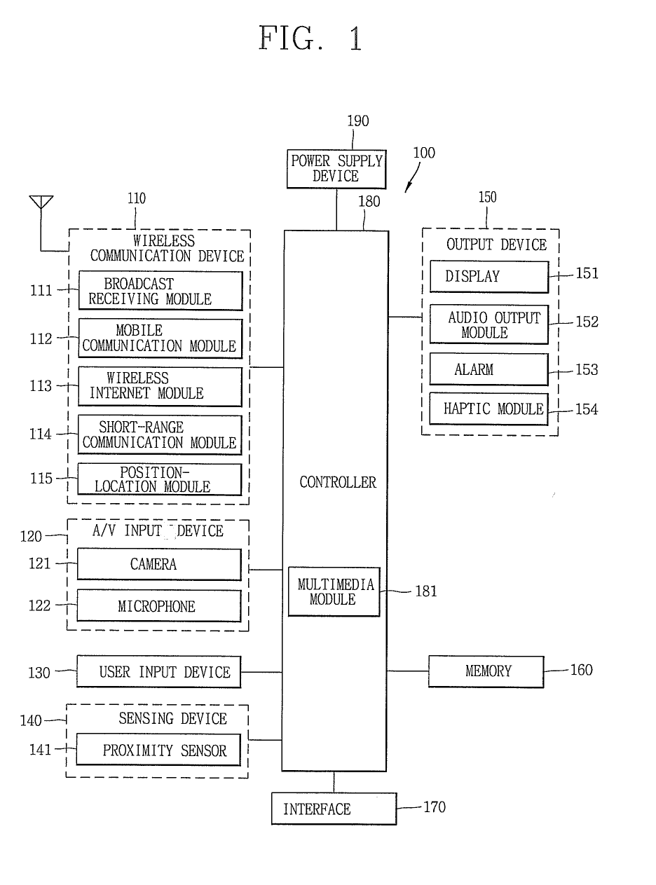

FIG. 1 is a block diagram illustrating a mobile terminal 100 associated with an exemplary embodiment.

The mobile terminal 100 may include a wireless communication unit 110, an Audio/Video (NV) input unit 120, a user input unit 130, a sensing unit 140, an output unit 150, a memory 160, an interface unit 170, a controller 180, a power supply unit 190, and the like. However, all of the elements as illustrated in FIG. 1 are not necessarily required, and the mobile terminal may be implemented with greater or less number of elements than those illustrated elements.

Hereinafter, the constituent elements will be described in turn.

The wireless communication unit 110 typically includes one or more elements allowing radio communication between the mobile terminal 100 and a wireless communication system, or allowing radio communication between the mobile terminal 100 and a network in which the mobile terminal 100 is located. For example, the wireless communication unit 110 may include a broadcast receiving module 111, a mobile communication module 112, a wireless Internet module 113, a short-range communication module 114, a location information module 115, and the like.

The broadcast receiving module 111 receives broadcast signals and/or broadcast associated information from an external broadcast management server through a broadcast channel.

The broadcast channel may include a satellite channel and/or a terrestrial channel. The broadcast management server may mean a server that generates and transmits a broadcast signal and/or broadcast associated information or a server that receives a previously generated broadcast signal and/or broadcast associated information and transmits to the mobile terminal 100. The broadcast signal may include a TV broadcast signal, a radio broadcast signal and a data broadcast signal as well as a broadcast signal in a form that a data broadcast signal is coupled to the TV or radio broadcast signal.

The broadcast associated information may mean information regarding a broadcast channel, a broadcast program, a broadcast service provider, and the like. The broadcast associated information may also be provided through a mobile communication network, and in this case, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may receive a broadcast signal using various types of broadcast systems. In particular, the broadcast receiving module 111 may receive a digital broadcast signal using a digital broadcast system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and the like. The broadcast receiving module 111 is, of course, configured to be suitable for every broadcast system that provides a broadcast signal as well as the above-mentioned digital broadcast systems.

Broadcast signals and/or broadcast associated information received via the broadcast receiving module 111 may be stored in a suitable device, such as a memory 160.

The mobile communication module 112 transmits and/or receives a radio signal to and/or from at least one of a base station, an external terminal and a server over a mobile communication network. In this exemplary embodiment, the radio signal may include a voice call signal, a video call signal and/or various types of data according to text and/or multimedia message transmission and/or reception.

The wireless Internet module 113 is a module for supporting wireless Internet access. The wireless Internet module 113 may be built-in or externally installed to the mobile terminal 100. In this exemplary embodiment, the wireless Internet module 113 may use a wireless Internet access technique including a Wireless LAN (WLAN), Wi-Fi, Wireless Broadband (Wibro), World Interoperability for Microwave Access (Wimax), High Speed Downlink Packet Access (HSDPA), and the like.

The short-range communication module 114 is a module for supporting a short-range communication. In this exemplary embodiment, it may be used a short-range communication technology including Bluetooth, Radio Frequency IDentification (RFID), Infrared Data Association (IrDA), Ultra WideBand (UWB), ZigBee, and the like.

The location information module 115 is a module for checking or acquiring a location of the mobile terminal, such as a GPS module.

Referring to FIG. 1, the A/V input unit 120 receives an audio or video signal, and the A/V input unit 120 may include a camera 121 and a microphone 122. The camera 121 processes an image frame, such as still picture or video, obtained by an image sensor in a video phone call or image capturing mode. The processed image frame may be displayed on a display unit 151.

The image frames processed by the camera 121 may be stored in the memory 160 or transmitted to an external device through the wireless communication unit 110. Two or more cameras 121 may be provided according to the use environment of the mobile terminal.

The microphone 122 receives an external audio signal through a microphone in a phone call mode, a recording mode, a voice recognition mode, and the like, and processes the audio signal into electrical voice data. The processed voice data may be converted and outputted into a format that is transmittable to a mobile communication base station through the mobile communication module 112 in the phone call mode. The microphone 122 may implement various types of noise canceling algorithms to cancel noise generated in a procedure of receiving the external audio signal.

The user input unit 130 may generate input data to control an operation of the terminal. The user input unit 130 may be configured by including a keypad, a dome switch, a touch pad (pressure/capacitance), a jog wheel, a jog switch, and the like.

The sensing unit 140 detects a current status of the mobile terminal 100 such as an opened or closed state of the mobile terminal 100, a location of the mobile terminal 100, existence or non-existence of a user contact, an orientation of the mobile terminal 100 and the like, and generates a sensing signal for controlling the operation of the mobile terminal 100. For example, when the mobile terminal 100 is a slide phone type, it may sense an opened or closed state of the slide phone. Furthermore, the sensing unit 140 takes charge of a sensing function associated with whether or not power is supplied from the power supply unit 190, or whether or not an external device is coupled to the interface unit 170. Meanwhile, the sensing unit 140 may include a proximity sensor 141.

The output unit 150 is configured to provide an output for audio signal, video signal, or alarm signal, and the output unit 150 may include the display unit 151, an audio output module 152, an alarm unit 153, a haptic module 154, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call. When the mobile terminal 100 is in a video call mode or image capturing mode, the display unit 151 may display a captured image and/or received image, a UI or GUI.

The display unit 151 may include at least one of a Liquid Crystal Display (LCD), a Thin Film Transistor-LCD (TFT-LCD), an Organic Light Emitting Diode (OLED) display, a flexible display, and a three-dimensional (3D) display.

Some of those displays may be configured with a transparent or optical transparent type to allow viewing of the exterior through the display unit, and such displays may be called transparent displays. An example of a typical transparent display may include a transparent LCD (TOLED), and the like. Under this configuration, a user can view an object positioned at a rear side of a terminal body through a region occupied by the display unit 151 of the terminal body.

The display unit 151 may be implemented in two or more in number according to a configured aspect of the portable terminal 100. For instance, a plurality of the display units 151 may be arranged on one surface to be spaced apart from or integrated with each other, or may be arranged on different surfaces.

In embodiments where the display unit 151 and a touch sensitive sensor (referred to as a touch sensor) have an interlayer structure (hereinafter, referred to as a touch screen), the display unit 151 may be used as an input device in addition to being used as an output device. The touch sensor may be implemented as a touch film, a touch sheet, a touch pad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also a touch pressure.

When touch inputs are sensed by the touch sensors, corresponding signals are transmitted to a touch controller (not shown). The touch controller processes the received signals, and then transmits corresponding data to the controller 180. Accordingly, the controller 180 may sense which region of the display unit 151 has been touched.

Referring to FIG. 1, a proximity sensor 141 may be arranged at an inner region of the portable terminal 100 covered by the touch screen, or near the touch screen. The proximity sensor may sense a presence or absence of an object approaching a surface to be sensed, or an object disposed near a surface to be sensed, by using an electromagnetic field or infrared rays without a mechanical contact. The proximity sensor has a longer lifespan and a more enhanced utility than a contact sensor.

The proximity sensor may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of convenience of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor senses proximity touch, and proximity touch patterns (e.g., distance, direction, speed, time, position, moving status, etc.). Information relating to the sensed proximity touch and the sensed proximity touch patterns may be output onto the touch screen.

The audio output module 152 may output audio data received from the wireless communication unit 110 or stored in the memory 160 in a call-receiving mode, a call-placing mode, a recording mode, a voice recognition mode, a broadcast reception mode, and the like. The audio output module 152 may output audio signals relating to functions performed in the mobile terminal 100, e.g., sound alarming a call received or a message received, and so on. The audio output module 152 may include a receiver, a speaker, a buzzer, and so on.

The alarm unit 153 outputs signals notifying occurrence of events from the mobile terminal 100. The events occurring from the mobile terminal 100 may include a call received, a message received, a key signal input, a touch input, and the like. The alarm unit 153 may output not only video or audio signals, but also other types of signals such as signals notifying occurrence of events in a vibration manner. Since the video or audio signals can be output through the display unit 151 or the audio output unit 152, the display unit 151 and the audio output module 152 may be categorized into a part of the alarm unit 153.

The haptic module 154 generates various tactile effects which a user can feel. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 154 may generate various tactile effects, including not only vibration, but also arrangement of pins vertically moving with respect to a skin being touched (contacted), air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 154 may be configured to transmit tactile effects (signals) through a user's direct contact, or a user's muscular sense using a finger or a hand. The haptic module 154 may be implemented in two or more in number according to the configuration of the mobile terminal 100.

The memory 160 may store a program for the processing and control of the controller 180. Alternatively, the memory 160 may temporarily store input/output data (e.g., phonebook data, messages, still images, video and the like). Also, the memory 160 may store data related to various patterns of vibrations and audio output upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the mobile terminal 100 may operate a web storage which performs the storage function of the memory 160 on the Internet.

The interface unit 170 may generally be implemented to interface the mobile terminal 100 with external devices. The interface unit 170 may allow a data reception from an external device, a power delivery to each component in the portable terminal 100, or a data transmission from the portable terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

The identification module may be configured as a chip for storing various information required to authenticate an authority to use the mobile terminal 100, which may include a User Identity Module (UIM), a Subscriber Identity Module (SIM), and the like. Also, the device having the identification module (hereinafter, referred to as ‘identification device’) may be implemented in a type of smart card. Hence, the identification device can be coupled to the mobile terminal 100 via a port.

Also, the interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals or power inputted from the cradle may operate as signals for recognizing that the mobile terminal 100 has accurately been mounted to the cradle.

The controller 180 can perform a pattern recognition processing so as to recognize writing or drawing input on the touch screen as text or image.

The power supply unit 190 provides power required by various components under the control of the controller 180. The provided power may be internal power, external power, or combination thereof.

Various embodiments described herein may be implemented in a computer-readable medium using, for example, software, hardware, or some combination thereof.

For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro processors, other electronic units designed to perform the functions described herein, or a selective combination thereof. In some cases, such embodiments are implemented by the controller 180.

For software implementation, the embodiments such as procedures and functions may be implemented together with separate software modules each of which performs at least one of functions and operations. The software codes can be implemented with a software application written in any suitable programming language. Also, the software codes may be stored in the memory 160 and executed by the controller 180.

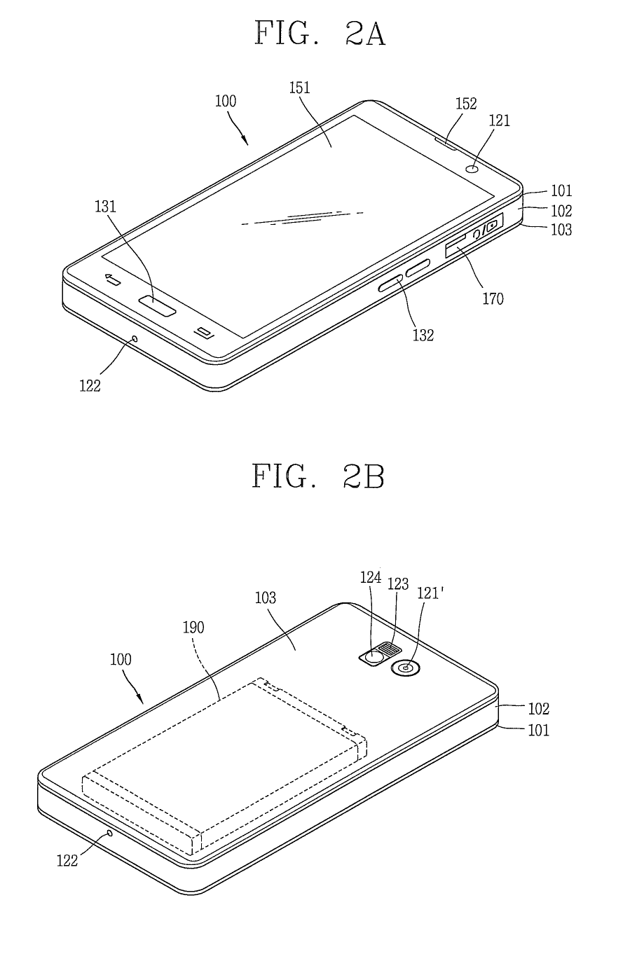

FIG. 2A is a front perspective view illustrating an example of a mobile terminal, and FIG. 2B is a rear perspective view of the mobile terminal shown in FIG. 2A.

Referring to FIGS. 2A and 2B, the mobile terminal 100 disclosed herein is provided with a bar-type terminal body. However, the present application is not limited to this type of terminal, but is also applicable to various structures of terminals such as slide type, folder type, swivel type, swing type, and the like, in which two or more bodies are combined with each other in a relatively movable manner. In addition, the mobile terminal disclosed herein may be applied to a random portable electronic device having a camera and a flash, examples of which may include a portable phone, a smart phone, a laptop computer, a digital broadcast terminal, a personal digital assistant (PDA), a portable multimedia player (PMP), and the like.

A body may include a case (or referred to as casing, housing, cover, etc.) defining an appearance of the mobile terminal 100. In this exemplary embodiment, the case may be divided into a front case 101, a rear case 102 for covering an opposite surface to the front case 101, and a battery cover 103 coupled to the rear case 102 to define a rear face of the mobile terminal 100. A space may be formed between the front and rear cases 101 and 102 so as to accommodate various electronic components. Such cases may be injected using a synthetic resin or be formed of a metal, such as stainless steel (STS), titanium (Ti) or the like.

The terminal body is shown having a display unit 151, an audio output module 152, a signal input unit 131, a front camera 121 and the like.

The display unit 151 may include a Liquid Crystal Display (LCD) module, an Organic Light Emitting Diodes (LED) module, an e-paper and the like for displaying visible information. The display unit 210 may include a touch sensing unit for allowing an input in a touching manner. Hereinafter, the display unit 210 having the touch sensing unit is referred to as ‘touch screen’. When a touch input is detected on any position on the touch screen 210, a content corresponding to the touched position may be input. The contents generated by such touch input may include text, numbers, instructions in various modes, menu items to be set, or the like. The touch sensing unit may be transparent so that the display unit can be viewed therethrough, and have a structure for enhancing visibility of the touch screen at a bright place. Referring to FIG. 2, the touch screen 210 occupies most of the front surface of the front case 201.

The audio output module 152 may be implemented as a receiver for forwarding a call sound to a user's ear or a type of a loud speaker for outputting various alarm sounds or a reproduction sound of multimedia.

The front camera 121 may process image frames, such as still images or video, obtained by an image sensor in a telephony call mode or a capturing mode. The processed image frames may be displayed on the display unit 151.

The image frames processed by the front camera 121 may be stored in the memory 160 or transmitted to an external device through the wireless communication unit 110. Two or more front cameras 121 may be provided according to the use environment of the mobile terminal.

The signal input unit 131 may be manipulated to receive a command for controlling operations of the mobile terminal 100, and may include a plurality of input keys. The input keys may be commonly designated as a manipulating portion, and any method may be employed if it is implemented in a tactile manner allowing the user to perform manipulation with a tactile feeling.

For example, the signal input unit 131 may be implemented as a dome switch, a touch screen or a touchpad allowing a user to input a command or information in a pushing or touching manner, or a wheel, a jog or a joystick for rotating a key. Various contents may be input by the signal input unit 131. For instance, the signal input unit 131 may allow for inputting commands, such as start, end, scroll, or the like.

a proximity sensor 141 may be arranged at an inner region of the portable terminal 100 covered by the touch screen, or near the touch screen. The proximity sensor may sense a presence or absence of an object approaching a surface to be sensed, or an object disposed near a surface to be sensed, by using an electromagnetic field or infrared rays without a mechanical contact. The proximity sensor has a longer lifespan and a more enhanced utility than a contact sensor.

The proximity sensor may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field.

The side surface of the front case 101 may include a side key 132, an interface unit (not shown), a microphone 122 and the like.

The side key 132 may be commonly designated as a manipulating portion, and any method may be employed if it is implemented in a tactile manner allowing the user to perform manipulation with a tactile feeling. The contents inputted by the side key 132 may be set in various ways. For example, the side key 214 may be set to receive commands, such as controlling of the image input units 121 adjusting a volume level output from the audio output module 152, converting the display unit 151 into a touch recognition mode.

The microphone 122 may be implemented, for example, as a type of microphone for receiving user's voice, other sounds and the like.

The interface unit 215 may serve as a path for data exchange between the mobile terminal 200 and external devices. For example, the interface unit 215 may be at least one of a connection terminal for connecting an earphone in a wireless or wired manner, a port for a short-range communication (for example, Infrared (IrDA) port, Bluetooth port, wireless LAN port, etc.) or power supply terminals for supplying power to the mobile terminal 200. The interface unit 215 may be implemented as a type of socket for accommodating an external card, such as a Subscriber Identification Module (SIM), User Identity Module (UIM), a memory card for storage of information.

The rear surface of the terminal body is shown having a battery (power supply unit) 240, a rear camera 221 and the like.

The rear surface of the terminal body is shown having a power supply unit 190, a rear camera 121′ and the like.

A flash 123 and a mirror 124 may be disposed adjacent to the rear camera 121′. The flash 123 may operate to light an object to be captured when taking the object using the rear camera 121′.

The mirror 124 can cooperate with the rear camera 121′ to allow a user to photograph himself in a self-portrait mode.

The rear camera 121′ may face a direction which is opposite to a direction faced by the front camera 121, and may have different pixels from those of the front camera 121.

For example, the front camera 121 may operate with relatively lower pixels (lower resolution). Thus, the front camera 121 may be useful when a user can capture his face and send it to another party during a video call or the like. On the other hand, the rear camera 121′ may operate with a relatively higher pixels (higher resolution) such that it can be useful for a user to obtain higher quality pictures for later use. The front and rear cameras 121 and 121′ may be installed in the terminal body to be rotatable or popped up.

The battery 190 may supply power to the mobile terminal 100. The battery 240 may be mounted in the terminal body or detachably coupled directly onto the outside of the terminal body.

The mobile terminal according to the present disclosure may be configured such that volume (volume level) of sound output from the audio output module 152 can be controlled without an input applied onto the display unit 151, the signal input unit 131 and the side key 132. Hereinafter, description will be given of a control method of adjusting volume of sound output from the audio output module 152 based on a voice control command input by a user or based on information relating to external environment of the mobile terminal 100.

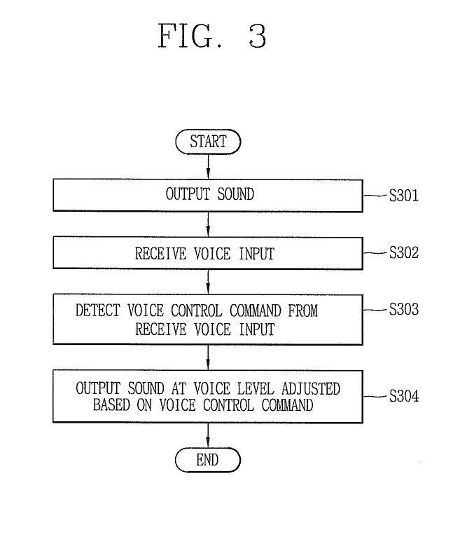

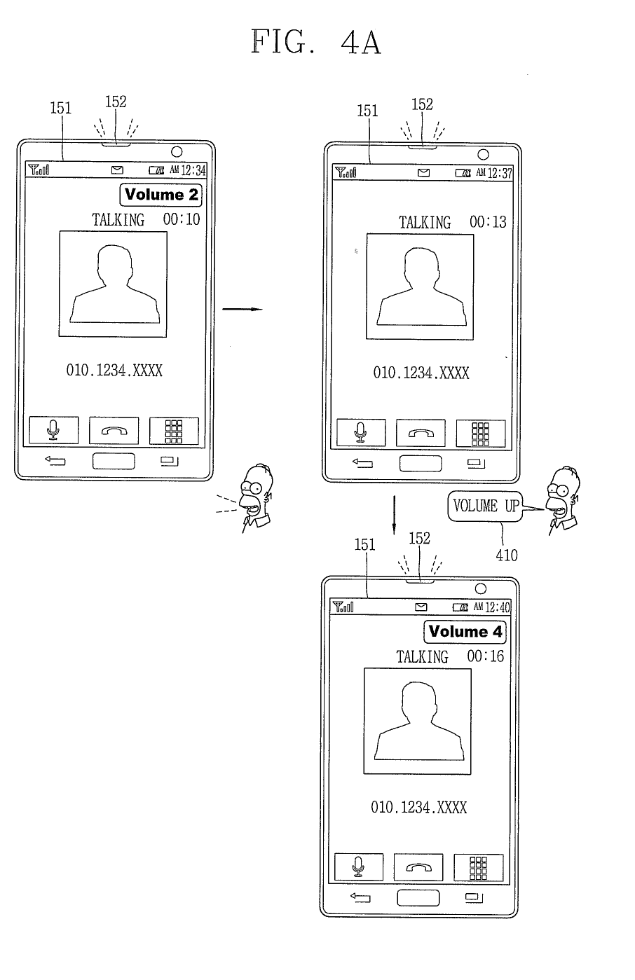

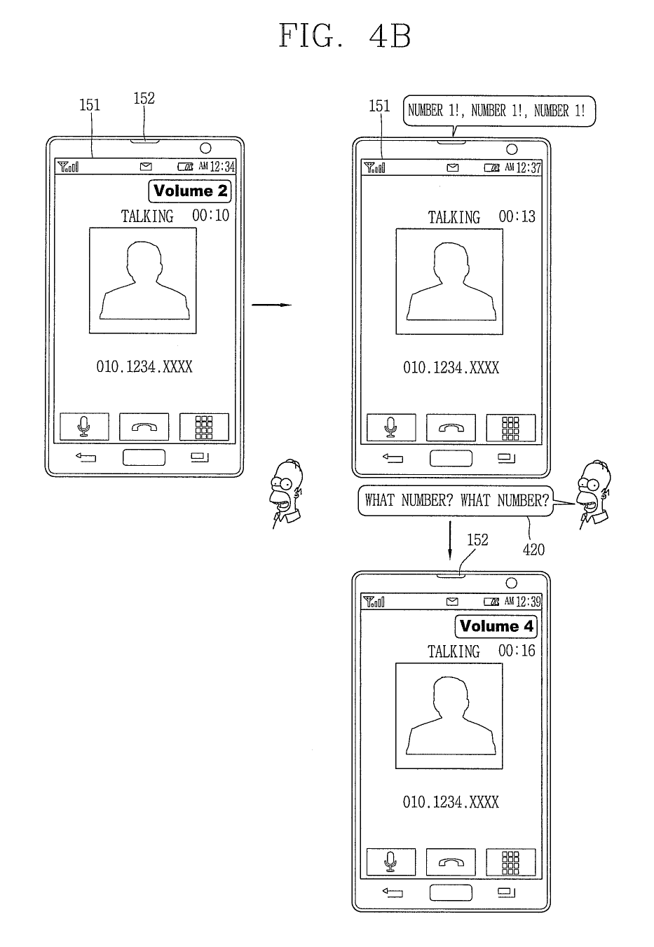

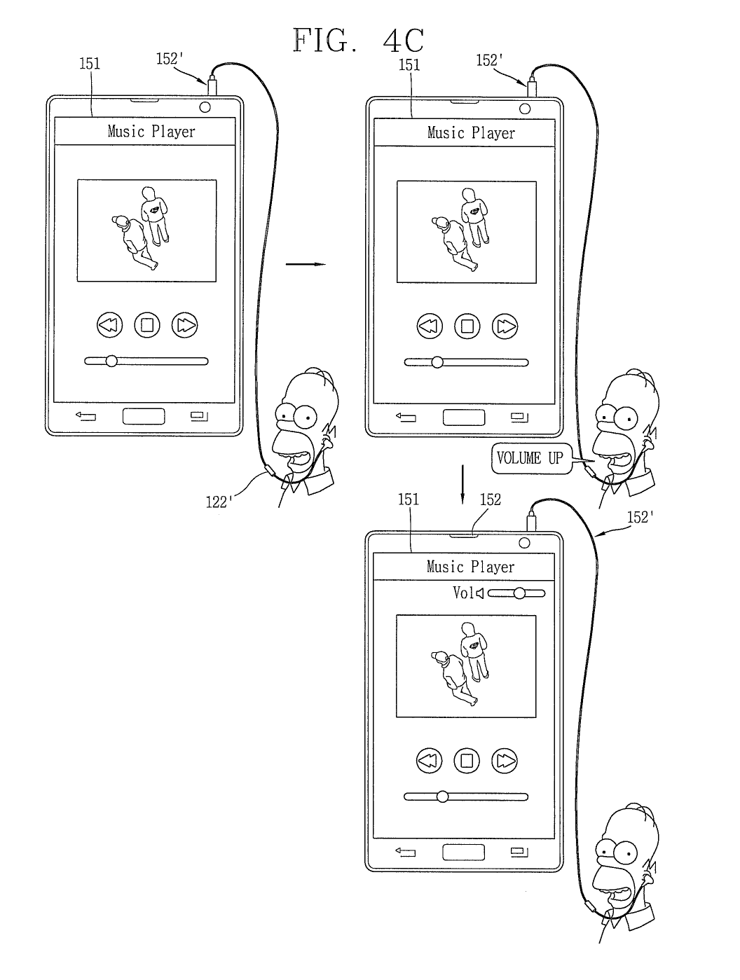

FIG. 3 is a flowchart showing a control method in accordance with the present disclosure, and FIG. 4A is a conceptual view showing the control method shown in FIG. 3 according to one exemplary embodiment. Hereinafter, description will be given of a control method of adjusting the volume of sound based on a user's voice control command while the sound is output via the audio output module 152 of the mobile terminal 100.

The audio output module 152 may output sound (S301). The audio output module 152 may be implemented as a receiver forwarding a call sound to a user's ear or a type of a loud speaker for outputting various alarm sounds or reproduction sounds of multimedia.

The sound may correspond to sounds included in music, songs or videos reproduced by the user, or sounds input into an external terminal by another party (callee, called party, etc.) which corresponds to a wireless signal received by the wireless communication unit 110 when the mobile terminal 100 is in a phone call mode. Here, the phone call mode refers to transmitting or receiving a wireless signal to or from an external terminal via the wireless communication unit 110. The wireless signal may correspond to a signal for forwarding sound input by a user into the mobile terminal or sound input by the another party into the external terminal.

This exemplary embodiment defines the sound as sound, which is input into an external terminal by another party, received by the wireless communication unit 110, when the mobile terminal 100 is wirelessly connected to the external terminal.

Referring to FIG. 4A, the controller 180 may convert the mode of the mobile terminal 100 into a phone call mode in response to a user's call control command. The user's call control command may correspond to a control command for controlling the wireless communication unit 110 to transmit a wireless call signal to the external terminal or to respond to a wireless call signal received from the external terminal.

During the phone call mode, the controller 180 may control the display unit 151 to display information relating to, for example, an image indicating another party who is a user of the external terminal (for example, the another party's image stored by the user), a phone number of the external terminal, a talk time with the another party, and the like.

Also, the controller 180 may control the display unit 151 to display a volume level of sound (for example, ‘Volume 2’) which the mobile terminal 100 is outputting during the phone call mode.

The position which the volume level is displayed on the display unit 151 may not be limited to that shown in the drawing. The controller 180 may also control the display unit 151 in the phone call mode to output the information in a temporary manner or a continuous manner according to settings. For example, the controller 180 may control the display unit 151 to output the information relating to the volume level of the sound for a preset short time, starting from the moment of conversion into the phone call mode, and thereafter stop to output the information.

Such information related to a volume level for outputting sound may be displayed on the display unit 151 upon an entrance into a phone call mode. Therefore, a user may estimate the volume of a ringing tone or user's voice to be output.

As shown in FIG. 4A-(A), in a phone call mode, the wireless communication unit 110 may transmit a wireless signal for the sound (tone) that another party (a called party or a callee) inputs to an external terminal, and the controller 180 may control the audio output module 152 to output the sound based on the wireless signal. That is, the user may receive the sound at the currently-set volume level.

During the phone call mode, the user's voice may be input into the microphone 122. Similar to the sound that the called party inputs to the external terminal, the user's voice input to the microphone 122 may be converted into a wireless signal, and transmitted to the external terminal via the wireless communication unit 110.

A detecting unit may detect a voice control command included in the voice (S302).

The voice control command may be a voice corresponding to at least one preset word. For example, the word may correspond to ‘Up’ or ‘Volume up’ as a control command for turning up the volume, ‘Volume 4’ including a number indicating a volume level desired to be adjusted or change thereto, and the like.

When the voice control command is input repetitively, the controller 180 may repetitively turn up or down the volume. For example, when a voice corresponding to ‘Up Up Up’ is input, the controller 180 may control the volume to be turned up by three steps. Also, when voice corresponding to ‘Down Down Down’ is input, the controller 180 may control the volume to be turned down by three steps.

The word corresponding to the voice control command may be, but limited to, a word which may imply the meaning of adjusting the volume, such as Up/Down, increase/decrease, too low/too loud and the like. For example, a meaningless voice or a word which implies a certain meaning but does not intimate the meaning of the volume adjustment may be set to the voice control command.

In order to distinguish a voice control command for volume adjustment from a user's (caller's) conversations with a called party, a voice which is not frequently used by the user may be preferable for the voice control command. Here, a word which may hint the volume adjustment may improve the user's intuition for the volume control.

The controller 180 may control the wireless communication unit 110 to block a wireless signal, which corresponds to the voice control command input during talking with the called party, from being transmitted to the external terminal. Accordingly, the called party may recognize a mute state in which anything is not heard while the voice control command is input.

Hence, the called party may not recognize the voice control command input by the user. This may allow the user and the called party to feel more comfortable during conversation, and prevent the called party's confusion, which may be caused when the called party recognizes the voice control command which is irrelevant to the conversation.

In response to the input of the voice control command, the controller 180 may control the audio output module 152 to adjust the volume and control the wireless communication unit 110 to transmit the wireless signal corresponding to a preset tone to the external terminal.

That is, when the voice control command is input, the called party may not recognize a word corresponding to the voice control command but recognize the preset tone. This may allow the called party to recognize that the user has adjusted the volume, which may result in preventing a problem in that the called party feels uncomfortable due to intermittent conversation.

Sounds may be output at the volume level adjusted based on the voice control command (S304).

The audio output module 152 may output the sound at the adjusted volume level, following the voice control command detected by the detecting unit.

Also, when different control commands for turning up and down the volume are distinctively input in a continuous manner, the controller 180 may adjust the volume in a sequential manner based on the commands.

Meanwhile, when the voice control command is input, the controller 180 may control the display unit 151 to display information relating to the adjusted volume level. The adjusted volume level may be displayed as follows, for example. That is, the controller 180 may control the display unit 151 to output text, such as ‘Volume 4,’ or an image which helps the user to recognize the level of the volume.

Accordingly, the user may adjust the volume of sound using his/her voice without use of a hand during the phone call mode, allowing for more convenient volume adjustment. Also, the speaker may be controlled by detecting the voice control command from the user's voice and the voice control command cannot be heard by the called party. This may result in more comfortable conversation in the phone call mode.

FIG. 4B is a conceptual view showing a method of adjusting volume of sound when the same voice is repetitively input during a phone call mode. This exemplary embodiment may be substantially the same as the exemplary embodiment shown in FIG. 4A in configuration except for the characteristic that the same voice is repetitively input through the microphone 122. Therefore, the repetitive description will be omitted.

Referring to FIG. 4B-(A), in a phone call mode of the mobile terminal 100, the controller 180 may control the display unit 151 to display a volume level of sound output.

When substantially the same or similar voice is repetitively input by the user through the microphone 122, the detecting unit may recognize the repetitive voice as the voice control command.

For example, when the sound output by the audio output module 152 and the voice input by the user correspond to ‘Number 1’, ‘What number?’, ‘Number 1’ and ‘What number?’ in an alternating manner, the detecting unit may recognize ‘What number?’ and ‘What number?’ as the same voice (word) being repetitively input, and detect it as the voice control command.

The case where the repetitive voice is input may correspond to a case where a voice corresponding to substantially the same or similar word is continuously input, a case where several voices corresponding to words having a similar meaning are continuously input, a case where voices which imply a question intonation (for example, pardon?, Sorry?) are repetitively input, and the like.

A pause time less than a preset time may be included between the repetitively input voices which are detected as the voice control command. Therefore, even if the voice corresponding to the same word is input several times during conversation between the calling party (i.e., the user) and the called party, when the pause time between the repetitively input voices is longer than the preset time, they may not be detected as the voice control command.

The repetitive voice may be defined by the user's setting. For example, when the user determines a volume as low or when the sound input into the external terminal by the called party is not clearly heard, a voice corresponding to a frequently used word or a voice having a particular intonation may be set to the repetitive voice.

Consequently, since various voices can be input into the mobile terminal 100 according to the user's way of talking, tone, intonation and the like, the repetitively input voice of those voices may be detected more correctly.

In the meantime, when the sound output by the audio output module 152 in response to the wireless signal, which the mobile terminal 100 has received from the external terminal, includes the repetitive voice, the controller 180 may control the detecting unit to detect the repetitive voice as the voice control command.

When the detecting unit detects the voice control command, the controller 180 may control the audio output module 152 to adjust the volume of the sound. For example, when the detecting unit detects the voices ‘What number?’ and ‘What number?’ of voices input by the user as the voice control command, the controller 180 may control the audio output module 152 to turn up the volume of the sound.

When the repetitive voice is detected as the voice control command, a level of the volume to increase may be controlled by the user's settings. For example, when the repetitive voice is detected as the voice control command, the controller 180 may control the audio output module 152 to increase the volume level step by step or apply different steps for increasing the volume level, according to the repeating level of the repetitive voice or a type of the voice.

The controller 180 may also determine whether or not the volume level adjusted based on the voice control command corresponds to a preset volume level, for example, the lowest volume level. When the adjusted volume level corresponds to the lowest volume level or the highest volume level, the controller 180 may ignore the detected voice control command.

When the voice control command is detected, the controller 180 may control the audio output module 152 to turn up the volume of the sound and the display unit 151 to display the increased volume level.

In accordance with this exemplary embodiment, the repetitive voice detected as the voice control command may be included in the conversation between the user (the calling party) and the called party so as to be forwarded to the called party. This may result in preventing the called party from feeling uncomfortable due to intermittent conversation or awkward from hearing the voice output.

FIG. 4C is a conceptual view showing a control method of adjusting music based on a voice control command in a reproducing mode of the mobile terminal for reproducing a music file or a video file. This exemplary embodiment may be substantially the same as the exemplary embodiment shown in FIG. 4A in configuration except for the characteristic that sound is output in the reproducing mode other than the phone call mode. Therefore, the repetitive description will be omitted.

Referring to FIG. 4C-(A), the controller 180 may control the audio output module 152 to reproduce a music file or a video file and output the sound at a preset volume level. Also, the controller 180 may control the display unit 151 to output visual information relating to the music file or the video file.

In this exemplary embodiment, the controller 180 may control the audio output module 152 and the interface unit to output the sound through an earphone 152′ of the mobile terminal 100 connected to the interface unit. The earphone 152′ may be provided with a microphone for receiving a user's voice thereby.

Referring to FIG. 4C-(B), the user's voice may be input via the microphone mounted on the earphone 152′. The controller 180 may control the detecting unit to detect a voice control command from the voice input through the microphone.

Here, there may not be much possibility that the user inputs other voices in addition to the voice control command during the reproducing mode for music and the like. Hence, when the voice is input through the microphone of the earphone 152′ in the reproducing mode, the controller 180 may control the detecting unit to recognize the voice as the voice control command.

For example, a user's voice ‘Volume up’ may be input through the microphone of the earphone 152′, and the detecting unit may recognize ‘Volume up’ as the voice control command.

The controller 180 may control the earphone 152′ and the interface unit to adjust the volume of the music and the like, which is output through the earphone 152′, based on the voice control command.

That is, the volume of the music may increase based on the voice control command detected by the detecting unit, and the display unit 151 may be controlled to output an image indicating that the volume has been turned up.

Accordingly, even when the mobile terminal 100 is in the reproducing mode and the user is listening to the music and the like through the earphone, the volume of the music and the like may be adjusted using the voice. That is, even while listening to the music and the like through the earphone, the user may adjust the volume of the music using the microphone mounted on the earphone, without adjusting the volume level with his hand.

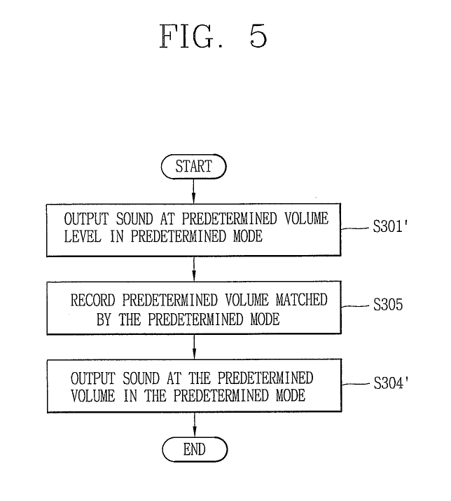

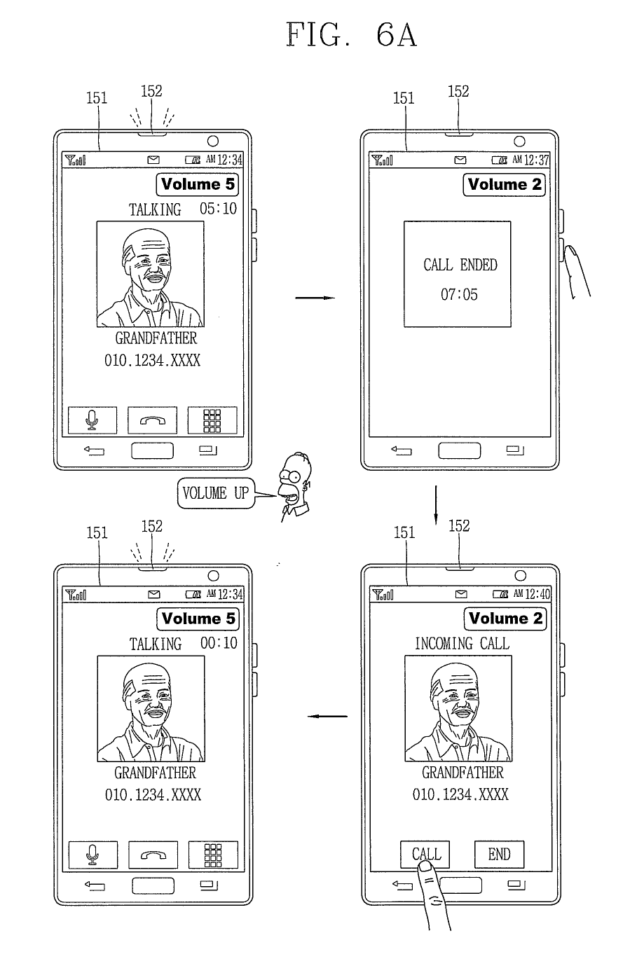

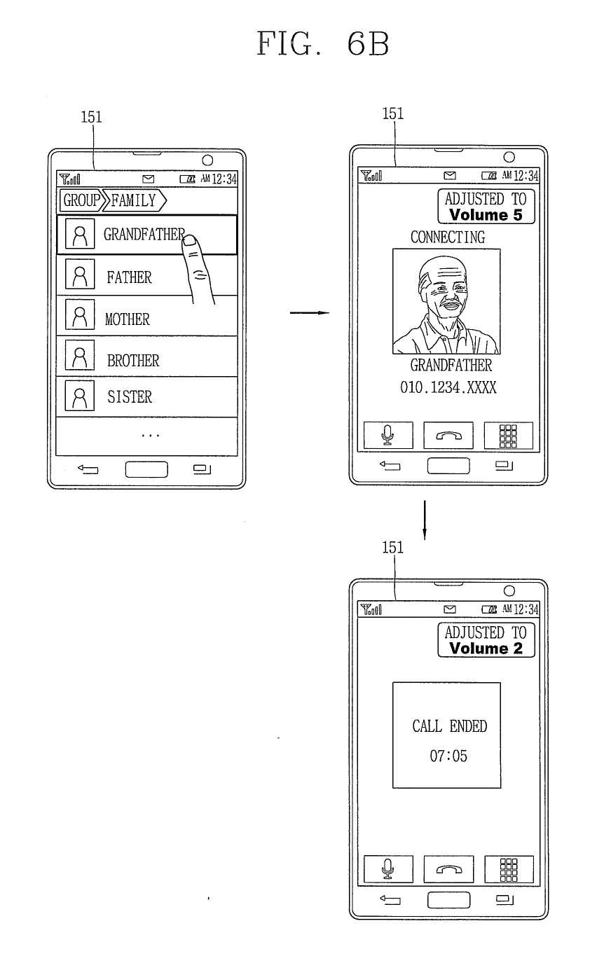

FIG. 5 is a flowchart showing a control method of adjusting a volume level based on a volume recorded in a memory of the mobile terminal. FIG. 6A is a conceptual view showing the control method of FIG. 5 in accordance with one exemplary embodiment.

The audio output module 152 of the mobile terminal 100 may output sound at a predetermined volume level in a predetermined mode (S301′). For example, the controller 180 may control the audio output module 152 to output sound at a predetermined volume level in a phone call mode. The predetermined volume level may be a volume set prior to conversion into the phone call mode or a volume set according to a user's control command after conversion into the phone call mode.

Here, the user's control command may correspond to at least one of the user's pressing onto the side key 132 upon conversion into the phone call mode and a voice control command detected from the user's voice by the detecting unit during the phone call mode.

The controller 180 may control the memory 160 to record information related to the volume level of the sound output by the audio output module 152 during the phone call mode (S305).

The information related to the volume of the sound stored in the memory 160 may correspond to a volume of the sound maintained for the longest time in the phone call mode, the latest volume of the sound maintained, or a volume of the sound initially changed upon conversion into the phone call mode.

Referring to FIG. 6A-(B), the phone call mode may be terminated and the volume of the sound may be adjusted in response to the user's control command. For example, in response to the user's control command, the volume of the sound may be adjusted from ‘Volume 5’ to ‘Volume 2’ as the user presses the side key 132.

In the meantime, when the mode of the mobile terminal 100 enters a predetermined mode again, the controller 180 may control the audio output module 152 to output sound at the predetermined volume (S304′).

For example, as shown in FIG. 6A-(C), when the volume of the sound output by the audio output module 152 has been set to ‘Volume 2,’ a wireless call signal may be received by the wireless communication unit 110. When the wireless call signal is received from an external terminal to the mobile terminal 100, the controller 180 may control the display unit 151 to output a graphic image on which a touch input is applied to convert the mode of the mobile terminal 100 into the phone call mode.

Referring to FIG. 6A-(D), in response to a touch input applied to the graphic image, the controller 180 may convert the mobile terminal 100 into the phone call mode and control the wireless communication unit 110 to execute a wireless communication with the external terminal.

When the mode of the mobile terminal 100 is converted into the phone call mode, the controller 180 may control the audio output module 152 to adjust the volume of the sound based on the volume information recorded in the memory.

For example, the controller 180 may control the audio output module 152 to output the sound at the volume level indicated by the volume information. That is, the audio output module 152 may output the sound, which the called party inputs to the external terminal, with the volume recorded in the memory based on the wireless signal transmitted from the external terminal.

That is, at ‘Volume 2’ in the released state of the phone call mode, when the mode of the mobile terminal 100 is converted into the phone call mode, the controller 180 may control the volume level to be adjusted to ‘Volume 5.’

That is, the controller 180 may automatically adjust the volume of the sound without a separate user's control command.

Therefore, in accordance with this exemplary embodiment, the controller 180 may control the volume of the audio output module 152 based on information related to a volume level adjusted to be optimized for the user. This may allow the volume of the sound to be adjusted without a separate control command.

In the meantime, the controller 180 may control the memory to remember (store, record) information relating to the volume of sound set in a reproducing mode for a video or music file as well as in the phone call mode, and control the audio output module 152 to adjust the volume of the sound based on the volume information.

Accordingly, even if the volume of the sound is adjusted by the user's control command after release of a predetermined mode, the volume of the sound may be automatically adjusted when the mode is converted back into the predetermined mode.

Also, the volume of the sound may be set by the user in the predetermined mode. For example, when the user has set the volume of sound to ‘Volume 5’ in the phone call mode, the controller 180 may control the audio output module 152 to adjust the volume of the sound, transmitted from the external terminal, to ‘Volume 5’ upon the mobile terminal 100 being converted into the phone call mode.

FIG. 6B is a conceptual view showing the control method of FIG. 5 in accordance with another exemplary embodiment. Hereinafter, description will be given of a control method of automatically adjusting the volume of sound output by the audio output module 152 according to external terminals which execute communications with the mobile terminal 100 in a wireless manner, with reference to FIG. 6B.

FIG. 6B-(A) is a conceptual view showing the display unit 151 which displays a list of external terminals which can communicate with the mobile terminal 100 in a wireless manner. For example, the display unit 151 may output screen information including a phone number and a representative name corresponding to each of a plurality of external terminals.

The representative name may be configured as a graphic image to which a touch input is applied for transmitting a wireless signal to an external terminal corresponding to the representative name. For example, in response to a touch input applied to one of the representative names, the controller 180 may control the wireless communication unit 110 to transmit a wireless call signal to the corresponding external terminal.

For example, when a user applies a touch input onto a graphic image on which a text (word) ‘Grandfather’ is presented, the controller 180 may control the wireless communication unit 100 to transmit a wireless call signal to an external terminal having a phone number corresponding to ‘Grandfather.’ Also, the controller 180 may control the display unit 151 to output an origination (dialing) screen, informing the user that it is trying to connect to the external terminal corresponding to ‘Grandfather.’

Here, the origination screen may include the text (or word) indicating ‘Grandfather,’ the phone number corresponding to ‘Grandfather,’ a representative image of the mobile terminal 100 (for example, a captured photo of a called party's face), and the like. Also, the origination screen may include a stop graphic image on which a control command is applied to release the connection with the external terminal, a keyboard graphic image for activating a keyboard image on which numbers and text are input during communication with the external terminal, and the like.

In accordance with this exemplary embodiment, the controller 180 may adjust the volume of the sound output by the audio output module 152 according to a connected external terminal, in response to the user's control command.

The memory may store information relating to a volume of sound, which matches the external terminal. The volume information which matches each external terminal may be set by the user. In the meantime, the controller 180 may control the memory to store volume information for the audio output module 152 to output the sound upon transmission and reception of wireless signals to and from the external terminal.

The volume information stored in the memory may correspond to a volume of sound maintained for the longest time in the phone call mode, the latest volume of sound maintained, or a volume of sound initially changed upon conversion into the phone call mode.

When the mobile terminal 100 is converted into the phone call mode to transmit and receive the wireless signals to and from the external terminal corresponding to ‘Grandfather,’ the controller 180 may control the audio output module 152 to adjust the volume of the sound based on the volume information stored in the memory, which matches the external terminal.

For example, the volume information, which is stored in the memory and matches the external terminal corresponding to ‘Grandfather,’ may correspond to ‘Volume 5.’ The volume information may be set by the user or correspond to volume information that the audio output module 152 outputs the sound when the mobile terminal 100 and the external terminal transmit and receive wireless signals to and from each other.

When the wireless communication unit 110 of the mobile terminal 100 transmits or receives a wireless signal to or from the external terminal corresponding to ‘Grandfather,’ the controller 180 may control the audio output module 152 to output the sound based on the volume information, which is stored in the memory and matches the external terminal. That is, the controller 180 may control the audio output module 152 to output the sound at the volume level ‘Volume 5.’

Also, the controller 180 may control the display unit 151 to display visual information indicating that the volume for outputting the sound from the called party has been adjusted to the volume level ‘Volume 5’ in the phone call mode.

Afterwards, when the wireless communication with the external terminal corresponding to ‘Grandfather’ is terminated, namely, when the phone call mode of the mobile terminal 100 is released, the controller 180 may control the audio output module 152 to adjust the volume of the sound. That is, the controller 180 may control the audio output module 152 to output the sound with the volume prior to converting the mode of the mobile terminal 100 into the phone call mode.

For example, the audio output module 152 may output the sound, which is received from the external terminal as the called party inputs the sound to the external terminal, at the volume level ‘Volume 5’ in the phone call mode, and then output the sound with the volume level ‘Volume 2’ when the phone call mode is released.

For example, when the mode of the mobile terminal is a reproducing mode for a music file and the like prior to being converted into the phone call mode, the controller 180 may control the audio output module 152 to output the music at the volume level ‘Volume 2’ other than ‘Volume 5’ after the phone call mode is released.

Although not shown, when the mobile terminal 100 executes wireless communication with an external terminal corresponding to ‘Father’ of the representative names of external terminals shown in FIG. 6B-(A), the controller 180 may control the audio output module 152 to output the called party's sound based on volume information which matches ‘Father.’

For example, the volume information matching ‘Father’ may correspond to the volume level ‘Volume 1.’ When the mobile terminal 100 is converted into the phone call mode, the controller 180 may control the audio output module 152 to output the sound of the called party at the volume level ‘Volume 1.’

In accordance with the exemplary embodiment, the controller 180 may control the audio output module 152 to output the sound by automatically adjusting the volume level to a volume level matching a predetermined external terminal, which is wirelessly connected to the mobile terminal 100. Therefore, the user may receive the sound with the volume, which is optimized for the sound of each called party, without a separate control command.

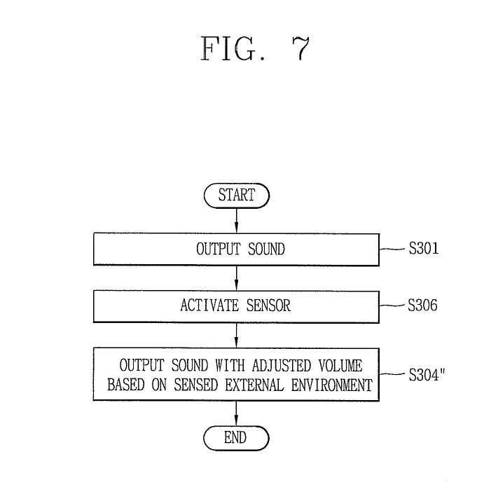

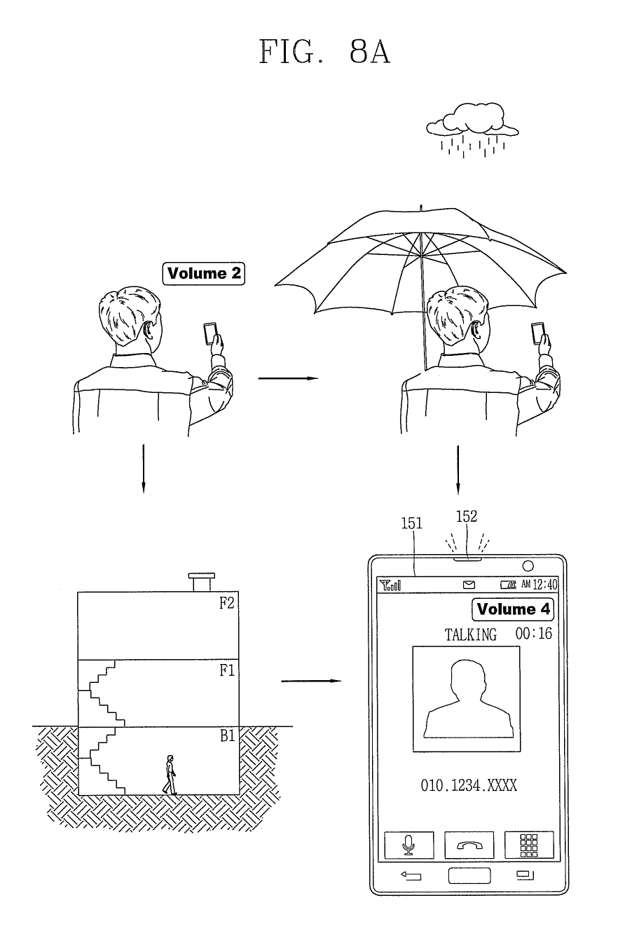

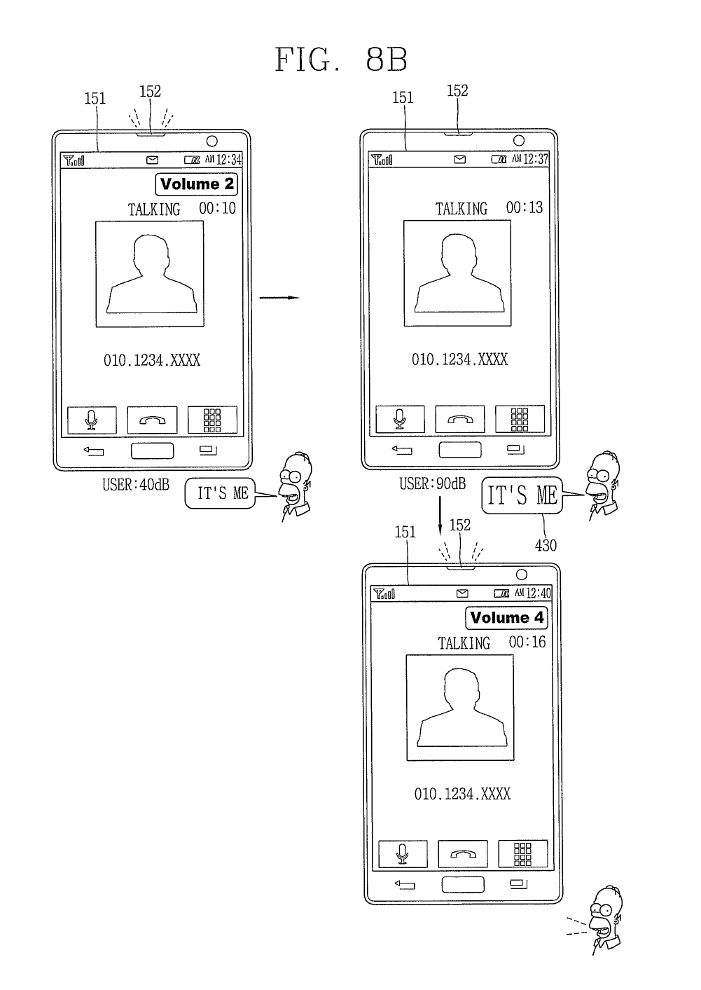

FIG. 7 is a flowchart showing a control method of adjusting volume using a sensor mounted in the mobile terminal, and FIG. 8 is a conceptual view showing the control method of FIG. 7 in accordance with exemplary embodiments.

The audio output module 152 of the mobile terminal 100 may output sound (S301). The sound may correspond to sounds that a called party corresponding to a wireless signal received via the wireless communication unit 110 in the phone call mode inputs to the external terminal, or music output in the reproducing mode. The sound may correspond to a currently set volume level, a volume level set according to each mode or a volume level matching an external terminal.

Also, the user may receive a sound output at the volume level through the audio output module 152, an earphone which is connected to the interface unit of the mobile terminal 100, and the like.

A sensor may be activated in response to a sensing control command (S306). The sensor may be configured to sense external environments of the mobile terminal. For example, the sensor may include a humidity sensor, a barometer, a global positioning system (GPS), a gyro sensor, a signal strength sensing sensor and the like.

The sensing control command may correspond to a control command instructing the audio output module 152 to output sound, for example, a sound output command based on a wireless signal received by the wireless communication unit 110 or an execution command of the reproducing mode of a music file and the like, applied by the user. That is, upon receiving a control command which instructing the audio output module 152 to output sound, the sensor may be activated.

In the meantime, the sensing control command may be distinguished from the control command instructing the audio output module 152 to output sound. The user may activate the sensor based on separate settings or by applying a touch input onto a sensing sensor execution icon or the like, output on the display unit 151.

Or, the voice control command may include the sensing control command. That is, when the detecting unit detects the voice control command, the sensor may be activated.

FIG. 8A is a conceptual view showing a control method of adjusting a volume using a humidity sensor. The humidity sensor is a sensor which detects humidity using a variety of physical and chemical phenomena associated with moisture in the air of the external environment of the mobile terminal 100. That is, the humidity sensor may sense the weather.

The mobile terminal 100 may transmit and receive wireless signals to and from the external terminal in the phone call mode. The audio output module 152 may output the called party's voice at the volume level ‘Volume 2.’

When the user applies the sensing control command onto the mobile terminal 100, the controller 180 may activate the humidity sensor. The humidity sensor may sense an external environment of the mobile terminal 100. As shown in the drawings, when the mobile terminal 100 is externally exposed in a rainy day, the humidity sensor may output humidity information relating to the external environment.

Sound may be output with a volume adjusted based on the sensed external environment (S304″). That is, the controller 180 may estimate the external environment of the mobile terminal 100 based on the humidity information, and control the audio output module 152 to output the sound at a volume level corresponding to the external environment. For example, the controller 180 may predict the weather state as raining based on the humidity information sensed by the humidity sensor.

Accordingly, the controller 180 may control the audio output module 152 to output the sound at the volume level corresponding to the rainy weather, or turning up or down the volume level of the sound by the difference from a preset volume level. The volume level corresponding to the weather state and the difference of the volume level may be set by the user.

When the mobile terminal 100 is externally exposed in the rainy weather, external noise and echoes due to the rain may act as interferences with the sound provided to the user. Therefore, the controller 180 may control the audio output module 152 to output the sound by turning up the volume when such weather state is predicted.

In the meantime, the controller 180 may adjust the echo phenomenon of the sound by adjusting the volume, in addition to adjusting the volume of the sound.

FIGS. 8A-(A), 8A-(C) and 8A-(D) are conceptual views showing a control method of adjusting a volume using a barometer. The barometer generally refers to a device for measuring atmospheric pressure, namely, a sensor which is mounted in the mobile terminal to sense a position of the mobile terminal 100 in a height direction.

The mobile terminal 100 may transmit and receive wireless signals to and from an external terminal in a phone call mode. The audio output module 152 may output a called party's voice at a volume level ‘Volume 2.’

When the user applies a sensing control command to the mobile terminal 100, the controller may activate the barometer. The barometer may sense an external environment of the mobile terminal 100. As shown in the drawings, when the mobile terminal 100 is located at the underground of a building, the barometer may output height information about the mobile terminal 100 based on the ground.

The controller 180 may predict the external environment to which the mobile terminal belongs based on the height information, and control the audio output module 152 to output sound at a volume level corresponding to the external environment. For example, the controller 180 may predict that the mobile terminal is located at the underground based on the height information sensed by the barometer.

Accordingly, the controller 180 may control the audio output module 152 to output the sound at the volume level corresponding to the underground or turn up or down the volume level of the sound by a difference from a preset volume level. The volume level corresponding to the position of the mobile terminal 100 and the difference of the volume level may be set by the user.

For example, when the mobile terminal 100 is located at the underground, it may mean that the mobile terminal 100 is located in a basement of a building, a tunnel, a subway and the like. The echo phenomenon may be expected although less noise is generated when the mobile terminal 100 is located within the basement of the building, and not only much noise but also the echo phenomenon may be expected when the mobile terminal 100 is located in the tunnel or subway. Therefore, the controller 180 may control the audio output module 152 to adjust the volume and the sound when the position of the mobile terminal 100 is predicted.

Also, the controller 180 may predict an external environment of the mobile terminal 100 based on a plurality of information output by a plurality of sensors mounted in the mobile terminal 100.

The controller 180 may control the display unit 151 to output ‘Volume 4’ indicating the adjusted volume level.

Although not shown, the controller 180 may control the volume of the sound by recognizing the position of the mobile terminal 100 and the building in which the mobile terminal 100 is located using the GPS. The controller 180 may predict an environment of an area in which the mobile terminal 100 is located by retrieving information relating to the corresponding area, and control the audio output module 152 to turn up or down the volume based on the predicted environment.

For example, when a user is located in an airport where airplanes making loud noise take off or land, the controller 180 may control the audio output module 152 to output the sound at an appropriate volume level based on the area information output via the GPS.

The controller 180 may also measure a speed that the mobile terminal 100 moves using the GPS, and control the audio output module 152 to adjust the volume level according to the change in the speed.

For example, when a user who was walking gets into a public transport, it may cause the change in the moving speed of the mobile terminal 100 sensed by the GPS. The controller 180 may control the audio output module 152 to adjust the volume level using the speed information output by the GPS. The faster the mobile terminal 100 moves, the more interferences with the sound, such as ambient noise and vibration, may be caused. Therefore, the controller 180 may control the audio output module 152 to turn up the volume of the sound.

Also, the volume level may be adjusted using a gyro sensor. For example, the gyro sensor may be used to measure a trembling level of the mobile terminal 100, namely, an angular velocity. Accordingly, the controller 180 may control the audio output module 152 to adjust the volume level using the angular velocity information output by the gyro sensor.

When a higher angular velocity is output by the gyro sensor of the mobile terminal 100, it may be expected that a stronger external force is applied to the mobile terminal 100. This may be predicted as an increase in interferences with the sound provided. Therefore, when the angular velocity measured by the gyro sensor increases, the controller 180 may control the audio output module 152 to turn up the volume.

The volume output by the audio output module 152 may be adjusted using a signal strength measured by a signal strength sensing sensor. The signal strength may refer to an amount of power for transmitting or receiving a wireless signal. A high signal strength may increase the quality of wireless communication.

When the signal strength is low, the user may be likely to fail to clearly receive a called party's voice transferred via the wireless communication unit 110. Therefore, the controller 180 may control the audio output module 152 to adjust the volume level to correspond to the signal strength.

In accordance with the exemplary embodiment, the user may receive sound with a volume appropriate for an environment without a separate control command.

FIG. 8B is a conceptual view showing a control method of adjusting volume of sound by sensing volume of a user's voice. The mobile terminal according to this exemplary embodiment may further include a volume measuring unit for measuring the volume of a user's voice input through the microphone 122.

FIG. 8B-(A) shows a case where the mobile terminal 100 is in a phone call mode. The user's voice may be input through the microphone 122 and the volume measuring unit may measure the user's voice input through the microphone 122. For example, 40 dB of volume may be measured from an initial voice in the phone call mode. The controller 180 may control the display unit 151 to display the measured volume when the volume of the user's voice is measured.

The volume of the user's voice input through the microphone 122 may be turned up or down. For example, as shown in FIG. 8B-(B), 90 dB of volume may be measured from the later voice input through the microphone 122.

When the mobile terminal 100 is in the phone call mode, the user may input a louder voice into the microphone 122 when noise generated near the user increases or the called party's voice output through the audio output module 152 is not clearly heard.

Hence, when the volume of the voice input through the microphone 122 increases, the controller 180 may control the audio output module 152 to turn up the volume of the sound output to the user accordingly. That is, the controller 180 may control the audio output module 152 to change the volume level to correspond to the change in the input volume measured by the volume measuring device or adjust the volume level to correspond to a volume level measured by the volume measuring device.

In accordance with the exemplary embodiment, the change in volume of the user's voice input through the microphone 122 may correspond to the voice control command described with reference to FIG. 4A. That is, the detecting device may detect the volume change in the user's voice as the voice control command. The controller 180 may control the audio output module 152 to turn up the volume of the sound output when the volume of the input voice increases, and turn down the volume of the output sound when the volume of the input voice decreases.

The volume measuring device may also measure ambient noise of the mobile terminal 100. Therefore, when the ambient noise of the mobile terminal 100 measured by the volume measuring device increases, the controller 180 may control the audio output module 152 to turn up the volume level.

Consequently, although the user does not intentionally input a voice control command to change the volume of sound, the change in the user's voice may be sensed in the phone call mode so as to control the volume of the sound output through the audio output module 152 more conveniently. Also, as the auto output module 152 may be controlled using the change in the user's voice, the volume of the sound may be adjusted more accurately to be appropriate for the user's environment.

In a mobile terminal and associated control methods, as embodied and broadly described herein, volume of sound may be adjusted using a user's voice control command, which may facilitate volume control even in a situation in which it is difficult to use a hand to make such an adjustment.

Also, the volume of the sound may be automatically adjusted using a sensor for sensing an external environment or by measuring the volume of the user's input voice, which may allow the user to receive output sound at an optimized volume.

A mobile terminal is provided that is capable of being controlled by voice.

A mobile terminal as embodied and broadly described herein may include an audio output module, a microphone, a detecting unit and a controller. The audio output module may be configured to output sound. The microphone may be configured to receive a user's voice input. The detecting unit may be configured to detect a voice control command for adjusting the volume of the sound of the user's voice, and the controller may be configured to control the audio output module to adjust the volume of the sound based on the voice control command.

In certain embodiments, the voice control command may correspond to a preset word.

In certain embodiments, the voice control command may include a plurality of voice commands output in a repetitive manner.

In certain embodiments, the mobile terminal may further include a volume measuring unit to measure the volume of the voice. Here, the controller may control the audio output module to adjust the volume of the sound to correspond to the measured volume of the voice.

In certain embodiments, the mobile terminal may further include a wireless communication unit to transmit or receive a wireless signal to and from an external terminal. The controller may convert a mode of the mobile terminal into a phone call mode when the wireless signal is received by the wireless communication unit. Here, the sound may be a voice of a called party corresponding to the wireless signal received by the wireless communication unit.

In certain embodiments, the mobile terminal may further include a memory to store volume information relating to sound output by the audio output module in the phone call mode. The controller may control the audio output module to adjust the volume of the sound based on the volume information.

In certain embodiments, the memory may store volume information corresponding to each of a plurality of external terminals. When the wireless communication unit is wirelessly connected to one of the plurality of external terminals, the controller may control the audio output module to adjust the volume of the sound based on the volume information corresponding to the one external terminal.

In certain embodiments, the controller may convert the mode of the mobile terminal into the phone call mode when the wireless communication unit receives the wireless signal, and the controller may control the audio output module to adjust the volume of the sound based on the volume information stored in the memory.

In certain embodiments, the volume information may be information relating to a volume maintained for the longest time while the wireless communication unit is wirelessly connected to each of the plurality of external terminals.

In certain embodiments, the mobile terminal may further include a sensing unit to sense an external environment of the mobile terminal and output sensing information relating to the external environment. The controller may control the audio output module to adjust the volume of the sound based on the sensing information.

In certain embodiments, the sensing unit may be activated based on the voice control command.

In certain embodiments, the sensing unit may include at least one of a humidity sensor, a global positioning system (GPS), a barometer, a signal strength sensing sensor and a gyro sensor.

In certain embodiments, the controller may control the audio output module to adjust the volume of the sound based on the voice control command input through the microphone in a reproducing mode of a music file or a video file.

A method of controlling a mobile terminal, as embodied and broadly described herein, may include outputting sound, receiving a user's voice input, detecting a voice control command for adjusting the volume of the sound of the user's voice, and adjusting the volume of the sound based on the voice control command.

In certain embodiments, the method may further include transmitting or receiving a wireless signal to or from an external terminal, and adjusting the volume of the sound corresponding to the wireless signal received from the external terminal based on the voice control command.

In certain embodiments, the method may further include converting the user's voice into a wireless signal to transmit to the external terminal. The transmitting of the wireless signal to the external terminal may include blocking transmission of a wireless signal corresponding to the voice control command of the user's voice.

In certain embodiments, the method may further include transmitting a wireless signal corresponding to a predetermined sound to the external terminal when the voice control command is detected.

In certain embodiments, the method may further include measuring a volume of the voice, and adjusting the volume of the sound based on the measured volume of the voice.

In certain embodiments, the method may further include storing volume information relating to the volume of the sound adjusted in a predetermined mode, and adjusting the volume of the sound based on the volume information when the predetermined mode is activated.

In certain embodiments, the method may further include sensing an external environment of the mobile terminal to output sensing information, and adjusting the volume of the sound based on the sensing information.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal, comprising:
an audio output module to output sound;
a microphone to receive a voice input;
a detecting device to detect a voice control command included in the voice input received by the microphone, the voice control command for adjusting a volume of sound output by the audio output module; and
a controller configured to receive the voice control command from the detecting device, and to control the audio output module to adjust the volume of the sound output by the audio output module based on the received voice control command.

2. The mobile terminal of claim 1, wherein the voice control command comprises a voice signal corresponding to at least one preset word.

3. The mobile terminal of claim 2, wherein the voice control command comprises a plurality of voice signals output in a repetitive manner.

4. The mobile terminal of claim 1, further comprising a volume measuring device to measure a volume of the voice input at the microphone, wherein the controller controls the audio output module to adjust the volume of the sound output by the audio output module to correspond to the measured volume of the voice input.

5. The mobile terminal of claim 1, further comprising a wireless communication device to transmit and receive wireless signals to and from external communication devices,
wherein the controller controls the mobile terminal in a phone call mode when a wireless signal is received by the wireless communication device, and
wherein the sound output by the audio output module is a voice signal generated by a communication device corresponding to the wireless signal received by the wireless communication device.

6. The mobile terminal of claim 5, further comprising a memory to store volume information related to sound output by the audio output module in the phone call mode.

7. The mobile terminal of claim 6, wherein the memory stores volume information corresponding to each of a plurality of external terminals, and
wherein, when the wireless communication device is wirelessly connected to one of the plurality of external terminals, the controller controls the audio output module to automatically adjust the volume of sound output by the audio output module based on the stored volume information corresponding to the one of the plurality of external terminals.

8. The mobile terminal of claim 6, wherein the controller converts the mode of the mobile terminal into the phone call mode in response to the wireless signal received by the wireless communication device, and
wherein the controller controls the audio output module to adjust the volume of the sound output by the audio output module based on volume information stored in the memory associated with the received wireless signal.

9. The mobile terminal of claim 6, wherein the volume information comprises historical operation data stored in the memory, and wherein the controller is configured to select, from the historical operation data, a volume level maintained for a longest period of time while the wireless communication is wirelessly respectively connected to each of the plurality of external terminals.

10. The mobile terminal of claim 1, further comprising a sensing device to sense an external environment of the mobile terminal and to output sensing information related to the external environment,
wherein the controller controls the audio output module to adjust the volume of the sound output by the audio output module based on the sensing information output by the sensing device.

11. The mobile terminal of claim 10, wherein the sensing device is activated based on the voice control command detected by the detecting device.

12. The mobile terminal of claim 11, wherein the sensing device comprises at least one of a humidity sensor, a global positioning system (GPS), a barometer, a signal strength sensor or a gyro sensor.

13. The mobile terminal of claim 1, wherein the controller controls the audio output module to adjust the volume of the sound output by the audio output module based on the voice control command received at the microphone in a playback mode of the mobile terminal for executing a music file or a video file.

14. A method of controlling a mobile terminal, the method comprising:
outputting sound;
receiving a voice input;
detecting a voice control command in the received voice input; and
adjusting a volume of the output sound in response to the voice control command.

15. The method of claim 14, wherein adjusting a volume of the output sound comprises:
transmitting a wireless signal to or receiving a wireless signal from an external terminal; and
adjusting the volume of the sound to a pre-set level corresponding to the external terminal based on the voice control command.

16. The method of claim 15, further comprising converting the voice input into a wireless signal to transmit to the external terminal, wherein transmitting the wireless signal to the external terminal comprises:
blocking transmission of a portion of the wireless signal corresponding to the voice control command so that the voice control command is not received by the external terminal.

17. The method of claim 16, further comprising:
transmitting a remaining portion of the wireless signal corresponding to a predetermined sound to the external terminal.

18. The method of claim 14, further comprising;
measuring a volume of the voice input; and
adjusting the volume of the output sound based on the measured volume of the voice input.

19. The method of claim 14, further comprising:
storing volume information including a plurality of volume levels respectively corresponding to operation of the mobile terminal in a plurality of predetermined modes; and
adjusting the volume of the sound to a respective volume level based on the stored volume information when one of the plurality of predetermined modes is activated.

20. The method of claim 14, further comprising:
sensing an external environment of the mobile terminal and outputting sensing information; and
adjusting the volume of the sound based on the sensing information.
